(19) United States
(12) Patent Application Publication
(10) Pub. No.: US 2019/0285344 A1
(43) Pub. Date: Sep. 19, 2019

(54) Inversion Hair Drying System

(71) Applicants: Tony Van Hammond, Miamisburg, OH (US); Lee Van Hammond, Miamisburg, OH (US); Edward Anthony Hammond, Dayton, OH (US)

(72) Inventors: Tony Van Hammond, Miamisburg, OH (US); Lee Van Hammond, Miamisburg, OH (US); Edward Anthony Hammond, Dayton, OH (US)

(21) Appl. No.: 16/355,007

(22) Filed: Mar. 15, 2019

Related U.S. Application Data
(60) Provisional application No. 62/644,572, filed on Mar. 18, 2018.

(51) Int. Cl. F26B 5/12; A45D 20/02; F26B 21/00; A47C 1/11

(52) U.S. Cl. CPC F26B 5/12; A45D 20/02; A47C 1/11; F26B 21/001; F26B 21/004

(57) ABSTRACT

An advanced assembly for drying hair without the use of heat by providing an opening covered by a screen allowing a person or animal to have their hair supported across the assembly's inlet opening as air is drawn through it by means of an internal adjustable blower unit and exhausted away from the user. The inlet screen being where the hair can be combed and styled during the process. Whereas the size and number of inlet openings of the assembly as well as the user controls can be set during design, the assembly can be embodied as a portable unit, a semi-stationary unit, or a permanent construct within a larger structure.

### CROSS-REFERENCE TO RELATED APPLICATIONS

The present application claims the benefit of priority to U.S. Provisional Patent Application 62/644,572, filed Mar. 18, 2018 with first named inventor Tony Van Hammond.

### BACKGROUND

### Field of the Invention

The present invention relates to a hair drying system and more particularly to an architecture which eliminates the need for the use of heat while drying and styling hair.

### Description of the Related Art

In today's modern world people are investing more than ever in their health and appearance. It has been widely known that extreme heat used during the drying process damages hair and the number and types of products in the market that are designed to prevent heat damage caused by heat-assisted hair drying is proof of that. In today's fast paced world where long hair is an acceptable fashion choice for men and women, the effort and time it takes to dry wet hair is widely understood. The need has never been greater for a way to dry hair expeditiously without causing undue damage in the process.

For the private individual and large salons alike, technology is advancing when it comes to hair care and styling. The main disadvantage of using heat is that it can damage the protein that makes up the hair and dehydrate the hair of natural oils that promote strength and a healthy appearance. There are many inventions that have been proposed in prior art regarding processes and invention for drying hair at home or professional scale.

For instance, a portable hair dryer system with rechargeable battery pack bearing U.S. Pat. No. 5,787,601A is issued to Christina Stelly. The patent discloses a hair dryer system that includes a rechargeable battery pack for supplying electrical power to both the air heating element and the blower fan; that includes an air filter holder for holding a replaceable air filter that can be replaced when clogged by lint and other airborne contaminants; and that includes a hair bonnet positionable over a user's head and an adjustable waist strap for securing a dryer housing containing the air heating element and the blower fan about the waist of the user.

An infrared hair dryer heater bearing U.S. Pat. No. 6,285,828B1 is issued to Helen of Troy, Helen of Troy LP. The patent discloses a hair dryer having both a fan-forced convection heater and radiant heater which emits energy having wavelengths in both the infrared and visible spectrum. The housing of the dryer is translucent to visible light but absorbent of infrared radiation and arranged to facilitate the transfer of heat generated by the absorption of the infrared radiation into the fan-forced airflow. The visible light emanating from the dryer provides an indicator of the dryer's operation and a warning of the presence of the otherwise invisible and otherwise dangerous infrared radiation.

A Portable hair dryer system bearing U.S. Pat. No. 2,010,028,2810A1 is issued to Edwina J. Hawes. The patent discloses a portable carrier for a hair dryer comprises a receptacle adapted to receive the hair dryer and one or more straps facilitating carrying of the portable carrier by a user. The portable carrier contains ventilation netting on a portion intended to cover air intake vents of the hair dryer. Openings are provided in the carrier to accommodate hair dryer cords and plugs. The hair dryer is preferably of a turtle shell shape and is powered by rechargeable batteries and remote controlled.

A Hair dryer and attachment system bearing U.S. Pat. No. 6,775,922B2 is issued to Wahl Clipper Corp. The patent discloses a hair dryer attachment system provides a dryer and a plurality of attachments. A fastening mechanism is provided so that multiple attachments are each securable to the generally circular or ovate dryer barrel using the same fastening technology. Each of the attachments forms part of the barrel, and when used with the preferred present shortened barrel, a so-called “standard-length” drier is provided which provides the additional benefits of the respective attachments, without being overly long so as to be cumbersome during use. Each attachment features an apron which is supported by the barrel and, with engagement formations on the barrel and complementary formations on the apron, the attachment is releasably secured to the barrel. Aeration barrel and finger/comb attachments are also provided.

A system for professional round brush blow-drying bearing U.S. Pat. No. 6,070,597A is issued to M. Head LLC. The present invention relates to a hair styling system having hair styling pieces and a handle. Each hair styling piece has bristles that extend radially outward from an elongated base that fits onto the end of a handle. One hair styling piece and the handle are drawn and held together with magnets and material that is attracted to the magnets.

A hair drying and shaping system bearing U.S. Pat. No. 7,093,376B2 is issued to Ennova Direct Inc. The patent discloses a hair drying and shaping system is provided and has a vacuum channel connected to a vacuum source for containing hair disposed therein for treatment; a hot air channel connected to a hot air source and having communication with the vacuum channel for measurable delivery of heated air into the vacuum channel; and a control interface for determining, setting, and activating features and parameters thereof during operation.

A hair dryer systems and methods and attachments for such hair dryer systems bearing U.S. Pat. No. 2,011,027,733,5A1 is issued to Barry V. Prehodka. The patent discloses a hair dryer system includes a hair dryer connectable to a power source and having a power connection, an attachment that is connectable to the power connection and is supplied power from the power source by the power connection. When the hair dryer is connected to the attachment by the power connection, the hair dryer and attachment consume a predetermined amount of power. When the hair dryer is disconnected from the attachment, the hair dryer consumes less power than the predetermined amount of power.

A Robotic hair dryer holder system with tracking bearing U.S. Pat. No. 9,408,452B1 is issued to K. Al-Khulaifi. The patent discloses a robotic hair dryer holder system with tracking and includes a robotic arm mounted to a base and a brush. The base mounts to a surface of a desired location for placement of the robotic arm. The robotic arm includes a plurality of articulating members that rotate and pivot with respect to each other. A hair dryer holder is attached to a distal end of the robotic arm and includes a motion detector. The hair dryer holder selectively holds a hair dryer, and the motion detector tracks a sensor element on the brush, causing the robotic arm to follow movements of the brush to dry a user's hair.

A Hair dryer assembly bearing U.S. Pat. No. 3,691,646A is issued to H. Ruffolo. The patent discloses a chair-type hair dryer wherein the flow of drying air is conducted through a system of obliquely directed passageways in a liner shell mounted within a drying helmet. The passageways are oriented to direct the drying air through the user's hair in a direction following the contour of the head toward the rear portion of the head and away from the face. Means are provided for selectively diverting a controllable portion of the drying air through a plurality of apertures in the back of the chair and against the user's back and shoulders providing a soothing and relaxing effect.

A Systems and methods for combing, drying, and straightening hair bearing U.S. Pat. No. 2,009,010,116,0A1 is issued to John P. Ruckart. The patent discloses the technology described herein provides systems and methods for combing, drying, and straightening hair with a device having one or more rows of teeth. Additionally, this technology provides for an adjustable tension mechanism that provides for the compression of hair, thus wringing it of water and providing the ability for a user to also straighten his or her hair. Furthermore, this technology provides for combing, drying, and straightening hair without utilizing an electric or heating means.

Another patent disclosing system, method, and appliances for applying hair treatments bearing U.S. Pat. No. 2,011,007,3129A1 is issued to PWAI LLC. The patent discloses a hair treatment foil includes a first hook fastener anchoring strip aligned with and proximal to a leading edge of the foil, and a second hook fastener anchoring strip offset from the first strip, the hooks of the second anchoring strip being taller and less dense than the hooks of the first anchoring strip. In embodiments, the hooks of the first anchor strip are offset or randomly placed, and/or the hooks of the second anchor strip are aligned or arranged in a mechanical weave pattern. A push flap is included for urging the foil forward after attachment. The leading edge may be pinked for picking and placing hair on the foil. Shoulders wider than the leading edge may be included. Embodiments include a retaining appliance having a base plate with a hooked fastener anchor strip attached to its underside and a pinked edge for picking of hair from underneath.

Looking at the prior art and market requirements, the need exists for an advancement that allows the hair to dry at a fast pace but with less damage. The proposed invention introduces a system which eliminates the use of heat while drying hair. The invention reduces the drying time and thus brings efficiency and effectiveness in the hair drying process. This assembly is especially useful on both a personal and commercial scale where large numbers of people are going through the hair drying process making cost and time optimization a priority.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is a general object of the present invention to provide an improved form of hair drying system which eliminates the need for the use of heat while drying hair.

More specifically, it is the principal object of this invention to provide an architecture which reduces the drying time compared to standard hair dryers in salons.

It is another object to provide an improved hair dryer that can thoroughly dry densely packed wet hair.

It is another object to provide such an improved hair dryer that can thoroughly dry such densely packed wet hair quickly without damaging the hair or scalp.

It is also the objective of the system to provide an assembly which is designed to provide maximum cost benefit, by creating a reduction in time and electricity needed for one of the more lengthy processes performed by individuals, stylists, salon owners, and businesses practicing such procedures.

According to another aspect, it is also the objective of the invention to provide an assembly which is designed to provide a tangle free procedure while drying hair.

According to another object of the invention it is proposed that the assembly will provide a relaxing and less stressful experience during the hair drying process.

It is also the objective of the invention to provide an assembly which is of durable configuration made of high-quality material. The inner parts of the assembly can sustain the high working temperature and commercial and industrial usage.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the terms “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to provide a hair drying system which reduces the amount of time it takes to dry hair without the use of heat.

Hair drying devices of various forms have been devised in the past. In the most typical form such prior art hair drying devices include a source of heat and an air blower which directs ambient air across the source and then onto the hair of the user. Devices of this kind, while suitable for their purpose, lack the precision, convenience, and control that are sometimes required in a commercial hair styling establishment. These devices also cause damage to the hair or create fatigue on the body with prolonged, intended, or inappropriate use.

To this end, various forms of apparatus have been designed, and those are used in hair-dressing salons; they usually comprise a kind of hood or helmet or head set which covers the customers head; on top of this head set there is provided an electric fan or ventilator which draws in the outside air and forces it through the hair to be dried, this air being pre-heated by means of an electric resistor (generally accommodated within the head set). In spite of the use of this contrivance, this procedure unfortunately requires a rather long time for drying the hair thoroughly, especially if the latter is full of curls or ringlets. The invention as per preferred embodiment presents a system for drying hair where the drying time is reduced compared to standard hair dryers without the use of heat. The invention further proposes to bring efficiency and effectiveness in the overall process allowing the user to dedicate less time to the hair drying process.

The invention as per its illustrative embodiment presents an assembly where the customer can sit in a relaxed position and rest one's neck on the neck pad. Hair is spread over the proposed assembly where the drying process will take place. The invention proposes to provide a hair drying assembly which is convenient in use, easily fabricated and installed, and requires little maintenance.

The present invention is to be operated by applying hair to the inlet screen where air flow is entering the enclosure by means of a blower unit. The blowing means is formed by the motor and fan unit, which is installed inside the assembly or enclosure in communication with the inlet opening, draws air into the enclosure through the screen on which hair is spread, promoting the exchange of moisture from the hair to the air flowing across it, thereby accomplishing the intended effect. In the present embodiment, the blower has an exhaust outlet which vents the moisture laden air to the atmosphere. Preferably, the exhaust outlet extends away from the user.

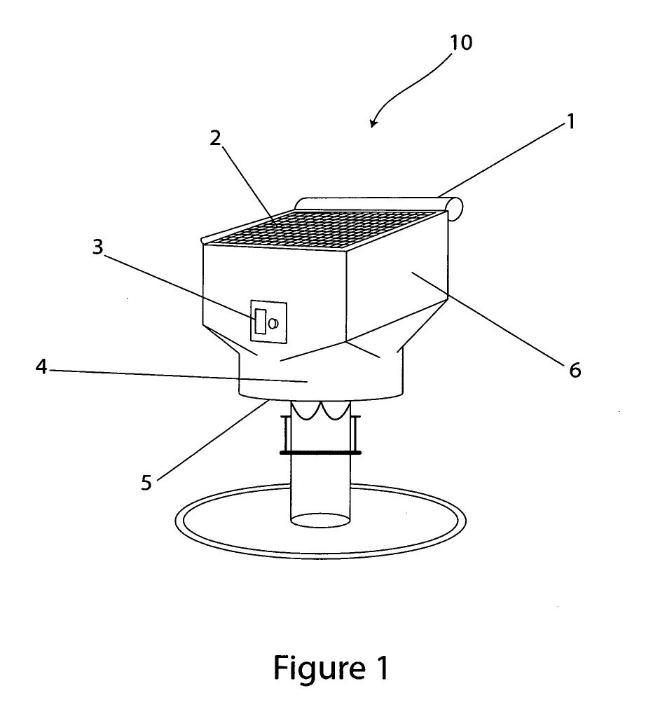

With reference to FIG. 1, in this example, an enclosure (6) may be of a molded plastic construction and includes a head and neck rest padded panel (1), where the user can rest their neck and relax. The enclosure (6) may be of any material strong enough to withstand the forces around the drying. The hair is spread over an inlet screen (2) which serves to prevent the hair from entering the body of the enclosure. In this example the inlet screen is a section of small diameter plastic screening held within a rectangular shaped metal frame over the inlet opening. An enclosure (6) has an internal adjustable blower unit (4) through which air is drawn into the enclosure from the inlet screen (2) outward through the exhaust outlet (5). In this example the blower unit (4) may be an electrically powered blower fan unit controlled by a user interface (3). The exhaust outlet (5) is situated at the bottom of Enclosure (6) to disperse the air from the unit.

The head and neck rest padded panel (1) is shown in FIG. 1 as having a substantially circular cross-section and extending along a top edge of the enclosure (6). The head and neck rest padded panel (1) may be of any cross-sectional shape and have a variable thickness. Additionally or alternatively, the head and neck rest padded panel (1) may extend along multiple edges or sides of the enclosure (6). The head and neck rest padded panel (1) may be removable or adjustable. The head and neck rest padded panel (1) may further comprise massaging or muscle relaxing capabilities. The head and neck rest padded panel (1) may comprise heating or cooling elements for the comfort of the user. The head and neck rest padded panel may also serve as a rest for one's hand or wrist.

The inlet screen (2) is shown in FIG. 1 as having a substantially square shape. In alternative embodiments, there may be any number of inlet screens (2) that are connected to an enclosure (6) and the inlet screen (2) may be any shape that may interface with the enclosure (6). In other embodiments, there may be a plurality of inlet screens (2) to cover the top of the enclosure (6). The inlet screen (2) may be replaceable or adjustable. Additionally or alternatively, the inlet screen (2) may have indication lights that are read by the user signifying state of operation. Additionally or alternatively, the inlet screen (2) may have a light signifying that the inlet screen (2) is in use.

The user control interface (3) as shown in FIG. 1 may comprise a one or more toggles, buttons, switches, dials, or any other apparatus by which a user may control an input into the adjustable blower unit (4). The user control interface may comprise one or more of an on/off switch, a power button, a high/medium/low setting, or a numerical setting for the strength of the adjustable blower unit (4). The user control interface (3) may further comprise Bluetooth connectivity, wherein a secondary device may control the functions of the hair dryer (10) remotely. Additionally or alternatively, the user control interface (3) may have a wired remote.

The exhaust outlet (5) is downstream of the blower unit (4). The exhaust outlet (5) may be any shape or size which allows the air to flow out of the enclosure (6). The enclosure (6) as shown is substantially rectangular, but may be of any shape with a top and a bottom which allows the head and next rest padded panel (1) to be affixed and able to enclose the blower unit (4). Alternatively, the enclosure (6) may be part of or connected to a wall or otherwise hidden from view, only allowing the inlet screen (2) to be visible and accessible. In other embodiments, the enclosure (6) may comprise wheels or other footing whereby the enclosure (6) may be moved about a room or surface.

The enclosure (6) may be smaller, and thereby allow the dryer (10) to be portable or handheld. Such embodiments may comprise handles. The enclosure (6) may be sized in a way for the user to stand behind it and use it standing.

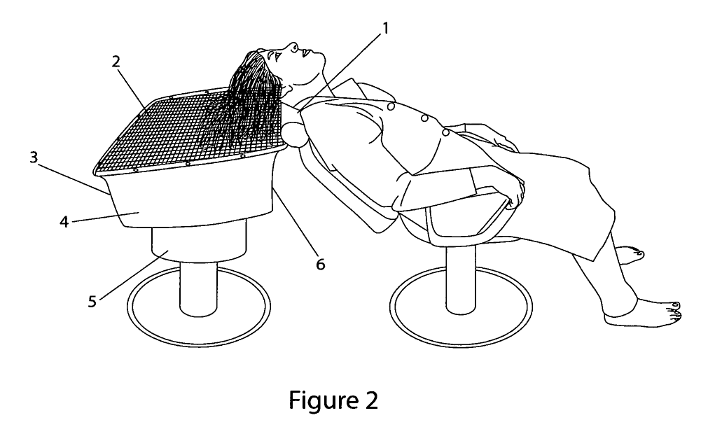

FIG. 2 is a front view of the rapid dryer (10) with a person using the dryer (10) as per present invention in an operating environment. The user can be seen resting their head on the head and neck on the rest assembly (1). The user's hair is spread on the inlet screen (2) into which the air will be drawn and user's hair will be dried through the use of the adjustable blower unit (4). The internal adjustable blower unit (4) is installed within the enclosure (6). The user will have control (3) to set the typical on and off or power settings. It is further contemplated that a second person may operate the dryer (10) while the user has their hair dried.

In alternative embodiments, the hair may be cut while before, during, or after the hair has been dried but while extended across the inlet screen (2). Additionally or alternatively, the hair may be moistened, dyed, or have any other chemical applied to it while the hair is extended across the inlet screen (2). In such embodiments, the enclosure (6) may comprise a catch basin between the adjustable blower unit (4) and the inlet screen (2) to catch the dye or chemicals and drain them after being applied to the hair.

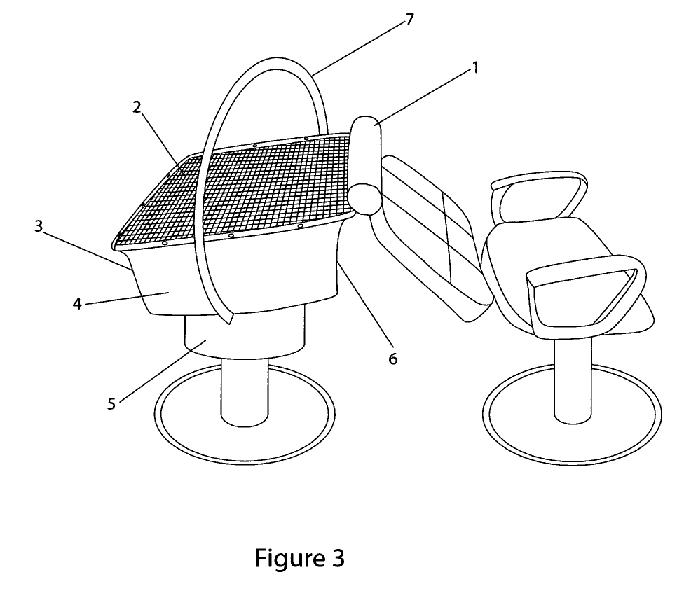

FIG. 3 is a schematic diagram of the front view of assembly where it is not in use. Once the user spreads their hair on inlet screen (2), the user or users will adjust the control (3) and the internal blower unit (4) secured within the enclosure (6) will start working. The blower unit (4) is mounted directly within the enclosure (6) and includes a exhaust line (5) for discharging moisture laden air. The embodiment shown in FIG. 3 is particularly mobile and adaptable to commercial use. In both of the embodiments shown in FIGS. 1 and 2, a actuated switch (3) is provided. As shown in FIG. 3, the dryer (10) may further comprise a positive pressure hose (7). The pressure hose (7) may be affixed to the exhaust outlet (5) and move any exhaust in a direction more conducive to providing a quiet and relaxing experience to a user. In some embodiments, there may be a plurality of pressure hoses (7). The pressure hose (7) may be of any cross-sectional shape or area, and/or length conducive to moving exhaust from the exhaust outlet (5). Additionally or alternatively, the pressure hose (7) may be flexible and/or removable. In alternative embodiments, there may be an attached seat or rest for the user to apply their body during use, or attachment points for apparatus designed to control animals to attach and provide assistance in their use of the hair dryer. In alternative embodiments, there may be a plurality of external trays or racks that assist in holding containers or other items useful during hair drying.

The hair of the user will be brushed either by the user or a second person depending on the application of use and the person whose hair is being dried may turn their head to adjust what hair comes into contact with the inlet screen. Completely drying hair can be achieved is much less time than what is commercially available currently

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A hair drying assembly comprising:
a head/neck rest support structure (1);
an inlet screen (2);
a user control (3);
an internal adjustable blower unit (4);
an exhaust outlet (5);
an enclosure containing internal configuration (6)

2. A combination of dryer and hair styling equipment where a hair dryer assembly includes a housing and a horizontal surface with an inlet for guiding air past a user's hair as it enters the enclosure where:
assembly is composed at least in part of heat-resistant, chemically resistant, and moisture resistant material;
where the horizontal frame comprises a plurality of openings for airflow;
where the power of the blower unit has the ability to be adjusted;
wherein the blower is controlled by a user control unit;
wherein the blower component can be powered by rechargeable batteries, conventional batteries, AC or DC power;
where the exhaust outlet removes the access air and maintain the temperature of assembly

3. A hair drying assembly, comprising:
An enclosure with an opening at the top and an exhaust outlet at the bottom and configured to allow airflow from the top to the bottom;
a head/neck support structure affixed to the enclosure;
an inlet screen configured to cover the opening at the top of the dryer housing;
a blower unit housed within the enclosure between the inlet screen and the exhaust outlet; and
a user control interface communicable to the blower unit and the head/neck rest.

4. The hair drying assembly of claim 3, wherein the user control interface comprises an on/off switch, power button, and/or intensity control.

5. The hair drying assembly of claim 3, wherein the user control interface is affixed to the enclosure.

6. The hair drying assembly of claim 3, wherein the user control interface is a separate device configured to control the blower unit.

7. The hair drying assembly of claim 6, wherein the user control interface is connect to the blower unit via Bluetooth or other wireless communication.

8. The hair drying assembly of claim 4, wherein the blower unit is adjustable.

9. The hair drying assembly of claim 3, further comprising a plurality of inlet screens.

10. The hair drying assembly of claim 3, wherein the inlet screen is replaceable or adjustable.

11. The hair drying assembly of claim 3, further comprising a light signifying the hair drying assembly is in use.

12. The hair drying assembly of claim 3, further comprising a catch basin downstream of the inlet screen and upstream of the blower unit, wherein the catch basin is configured to catch moisture, dies, or other chemicals applied to hair resting on the inlet screen and guide the moisture, dies or other chemicals to the edge or out of the enclosure.

13. The hair drying assembly of claim 3, further comprising a hose affixed to the exhaust outlet.

14. The hair drying assembly of claim 3, further comprising of wheels or a type of footing on the surface that contacts the ground to allow easy movement about any surface.

15. The hair drying assembly of claim 3, further comprising of an enclosure that is built into a larger structure that only exposes the inlet screen and headrest

16. The hair drying assembly of claim 3, further comprising of an attached seat or rest for the user to apply their body during use.

17. The hair drying assembly of claim 3, further comprising of anchor points that assist in keeping animals such as horses close to the hair dryer as their tails or manes are being dried.

18. The hair drying assembly of claim 1, embodied to be handheld

19. The hair drying assembly of claim 3, further comprising of a plurality of external trays or racks that assist in holding containers or other items useful during hair drying.
